(19) United States
(12) Patent Application Publication
(10) Pub. No.: US 2024/0377836 A1
(43) Pub. Date: Nov. 14, 2024

(54) PROCESSING METHOD, PROCESSING SYSTEM, AND PROGRAM PRODUCT THEREOF

(71) Applicant: DENSO CORPORATION, Kariya-city (JP)

(72) Inventor: SHUN SHIMIZU, Kariya-city (JP)

(21) Appl. No.: 18/781,863

(22) Filed: Jul. 23, 2024

Related U.S. Application Data
(63) Continuation of application No. PCT/JP2022/040230, filed on Oct. 27, 2022.

(30) Foreign Application Priority Data
Jan. 26, 2022 (JP) 2022-010353
Oct. 10, 2022 (JP) 2022-162851

(51) Int. Cl. G05D 1/243; B60W 60/00; G01C 21/00; G05D 1/246; G05D 111/30

(52) U.S. Cl. CPC G05D 1/243; B60W 60/0011; G01C 21/3811; G05D 1/246; B60W 2420/54; G05D 2111/30

(57) ABSTRACT

A processing method, which is executed by a processor to execute a process associated with automated driving of a moving body, includes: extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and generating, based on the automated driving data, factor analysis data correlated with the sound evaluation data as a result of analyzing a factor of the automated driving state at the analysis traveling point. The generating of the factor analysis data includes: selecting the automated driving data correlated with the sound evaluation data; and generating the factor analysis data based on the selected automated driving data.

### CROSS REFERENCE TO RELATED APPLICATIONS

The present application is a continuation application of International Patent Application No. PCT/JP2022/040230 filed on Oct. 27, 2022, which designated the U.S. and claims the benefit of priority from Japanese Patent Application No. 2022-010353 filed on Jan. 26, 2022 and Japanese Patent Application No. 2022-162851 filed on Oct. 10, 2022. The entire disclosures of all of the above applications are incorporated herein by reference.

### TECHNICAL FIELD

The present disclosure relates to a processing method, processing system, and program product, each of which is associated with automated driving of a moving body.

### BACKGROUND

Conventionally, a technology for generating and providing a map for driving an automated driving vehicle is known. In this technology, the map is generated based on evaluation performed depending on acceleration data values of a moving body, that is, the automated driving vehicle.

### SUMMARY

The present disclosure provides a processing method, which is executed by a processor to execute a process associated with automated driving of a moving body. The processing method includes: extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and generating, based on the automated driving data, factor analysis data correlated with the sound evaluation data as a result of analyzing a factor of the automated driving state at the analysis traveling point. The generating of the factor analysis data includes: selecting the automated driving data correlated with the sound evaluation data; and generating the factor analysis data based on the selected automated driving data.

### BRIEF DESCRIPTION OF DRAWINGS

Objects, features and advantages of the present disclosure will become apparent from the following detailed description made with reference to the accompanying drawings. In the drawings:

FIG. 1 is a block diagram illustrating an overall configuration of a processing system according to a first embodiment;

FIG. 2 is a block diagram illustrating an overall configuration of a control system according to the first embodiment;

FIG. 3 is a block diagram illustrating a functional configuration of the control system according to the first embodiment;

FIG. 4 is a flowchart illustrating a map generation procedure according to the first embodiment;

FIG. 5 is a block diagram illustrating a functional configuration of the processing system according to the first embodiment;

FIG. 6 is a flowchart illustrating a processing procedure according to the first embodiment;

FIG. 7 is a schematic diagram for explaining the processing procedure according to the first embodiment;

FIG. 8 is a schematic diagram for explaining the processing procedure according to the first embodiment;

FIG. 9 is a schematic diagram for explaining the processing procedure according to the first embodiment;

FIG. 10 is a schematic diagram for explaining the processing procedure according to the first embodiment;

FIG. 11 is a schematic diagram for explaining the processing procedure according to the first embodiment;

FIG. 12 is a schematic diagram for explaining the processing procedure according to the first embodiment;

FIG. 13 is a schematic diagram for explaining the processing procedure according to the first embodiment;

FIG. 14 is a schematic diagram for explaining the processing procedure according to the first embodiment;

FIG. 15 is a schematic diagram for explaining the processing procedure according to the first embodiment;

FIG. 16 is a schematic diagram for explaining the processing procedure according to the first embodiment;

FIG. 17 is a block diagram illustrating a functional configuration of a processing system according to a second embodiment;

FIG. 18 is a flowchart illustrating a processing procedure according to the second embodiment;

FIG. 19 is a schematic diagram for explaining the processing procedure according to the second embodiment;

FIG. 20 is a schematic diagram for explaining the processing procedure according to the second embodiment;

FIG. 21 is a schematic diagram for explaining the processing procedure according to the second embodiment;

FIG. 22 is a block diagram illustrating a functional configuration of a processing system according to a third embodiment;

FIG. 23 is a flowchart illustrating a processing procedure according to the third embodiment; and

FIG. 24 is a flowchart illustrating a processing procedure according to a modification example of the first embodiment shown in FIG. 6.

### DETAILED DESCRIPTION

In the above-described technology for generating and providing a map for automated driving, evaluation results dependent on the acceleration data values are merely added to the map. According this configuration, data may become insufficient for evaluating the automated driving vehicle thereby appropriately extracting a problem existing in the automated driving.

According to a first aspect of the present disclosure, a processing method is executed by a processor to execute a process associated with automated driving of a moving body. The processing method includes: extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and generating, based on the automated driving data, factor analysis data correlated with the sound evaluation data as a result of analyzing a factor of the automated driving state at the analysis traveling point. The generating of the factor analysis data includes: selecting the automated driving data correlated with the sound evaluation data; and generating the factor analysis data based on the selected automated driving data.

According to a second aspect of the present disclosure, a processing system executes a process associated with automated driving of a moving body. The processing system includes a computer-readable non-transitory storage medium and a processor. The process, by executing a program stored in the computer-readable non-transitory storage, is configured to: extract, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and generate, based on the automated driving data, factor analysis data correlated with the sound evaluation data as a result of analyzing a factor of the automated driving state at the analysis traveling point. In generation of the factor analysis data, the processor is configured to: select the automated driving data correlated with the sound evaluation data; and generate the factor analysis data based on the selected automated driving data.

According to a third aspect of the present disclosure, a processing program product is stored in a computer-readable non-transitory storage medium, and includes executed by a processor to execute a process associated with automated driving of a moving body. The instructions includes: extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and generating, based on the automated driving data, factor analysis data correlated with the sound evaluation data as a result of analyzing a factor of the automated driving state at the analysis traveling point. The generating of the factor analysis data includes: selecting the automated driving data correlated with the sound evaluation data; and generating the factor analysis data based on the selected automated driving data.

In the above first to third aspects, the (i) automated driving data representing the automated driving state of the moving body at the analysis traveling point and (ii) the sound evaluation data representing the evaluation from the operator regarding the automated driving state are extracted from the dynamic data embedded in association with the traveling point of the moving body on the digital map. According to the first to third aspects, the factor analysis data correlated with the sound evaluation data is generated based on the automated driving data as a result of analyzing the factor of the automated driving state at the analysis traveling point. Therefore, according to the generated factor analysis data, it becomes possible to extract a problem existing in the automated driving from the analyzed factor.

According to a fourth aspect of the present disclosure, a map generation method is executed by a processor to generate the digital map to be provided to the processing method according to the first aspect associated with automated driving of a moving body. The map generation method includes: acquiring automated driving data representing an automated driving state of the moving body; acquiring sound evaluation data representing evaluation by a sound from an operator regarding the automated driving state; embedding, as dynamic data, the automated driving data and the sound evaluation data in the digital map; and storing the digital map in which the automated driving data and the sound evaluation data are embedded in a storage medium correlated to a traveling point of the moving body.

According to the fourth aspect, not only the automated driving data representing the automated driving state of the moving body, but also the sound evaluation data representing evaluation by the sound from the operator regarding the automated driving state can be acquired in real time during the automated driving. Further, the acquired automated driving data and the sound evaluation data are embedded in the digital map as dynamic data correlated to a traveling point of the moving body, and then stored in the storage medium. Thus, the digital map stored in the storage medium can be used as the digital map provided to the processing method of first aspect for extracting a problem existing in the automated driving.

According to a fifth aspect of the present disclosure, a storage medium stores the digital map generated by the map generation method according to above-described fourth aspect.

The digital map stored in the storage medium of the fifth aspect can be used, for the same principle explained in the fourth aspect, as the digital map to be provided to the processing method of the first aspect for extracting a problem existing in the automated driving.

The following will describe embodiments of the present disclosure with reference to the accompanying drawings. Same explanations are omitted in some cases by giving identical reference characters to corresponding elements in different embodiments. In a case where only a part of configuration is explained regarding each embodiment, the configuration of another embodiment explained before can be applied to the remaining part of the configuration. Furthermore, the combination of configuration clearly depicted in the explanation of each embodiment is not the sole example, but the configuration of multiple embodiments can be combined with each other partially even if the combination is not clearly depicted, as long as such combination does not cause any problems particularly.

### First Embodiment

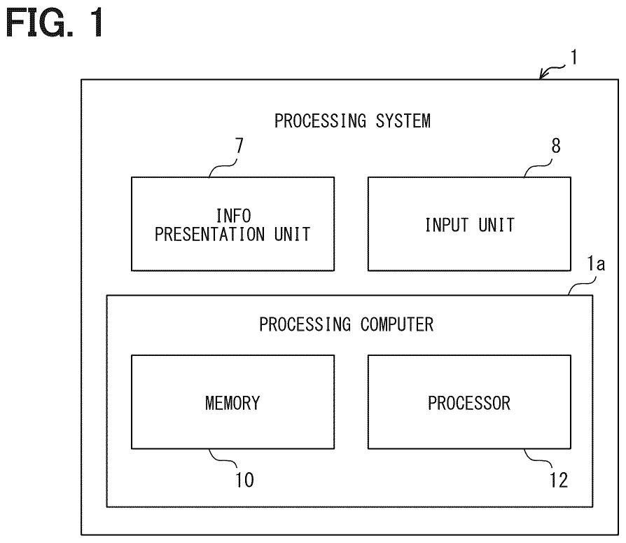

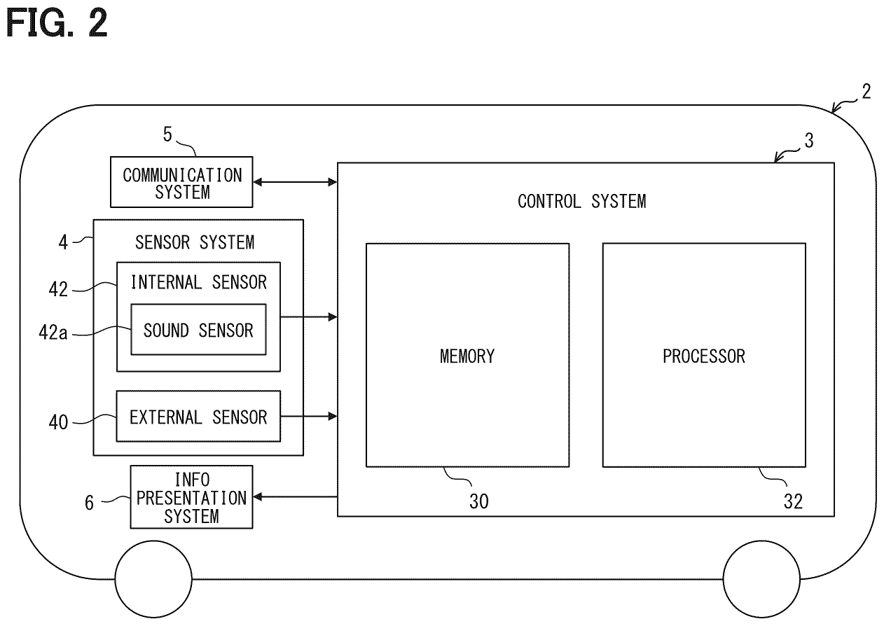

A processing system 1 of a first embodiment depicted in FIG. 1 executes a process associated with automated driving of a moving body 2 depicted in FIG. 2 (hereinafter, referred to as an automated driving-related process).

A control system 3 of the first embodiment depicted in FIG. 2 controls automated driving of the moving body 2. Here, in the first embodiment, the moving body 2 is, for example, an automobile or the like that can travel on a traveled road in a state where a boarded operator who is an occupant is on board. Automated driving control of such a moving body 2 is implemented at different levels depending on the degree of manual intervention in driving tasks by the boarded operator. Automated driving control may be implemented by autonomous traveling control, like conditional driving automation, high driving automation, or full driving automation, in which a system executes all driving tasks at the time of operation. Automated driving control may be implemented by high driving assistance control, like driver assistance or partial driving automation, in which the boarded operator executes some or all driving tasks. Automated driving control may be implemented by either one of or the combination of autonomous traveling control and high driving assistance control, or may be implemented by switching between autonomous traveling control and high driving assistance control.

A sensor system 4, a communication system 5, and an information presentation system 6 are mounted the moving body 2. By performing sensing in the spaces outside and inside the moving body 2, the sensor system 4 acquires sensor data that can be used by the control system 3. For this purpose, the sensor system 4 includes an external sensor 40 and an internal sensor 42.

The external sensor 40 acquires external data as sensor data from an outer space which is the surrounding environment of the moving body 2. The external sensor 40 may acquire the external data by sensing targets that are in the space outside the moving body 2. The target-sensing-type external sensor 40 is at least one type selected from, for example, a camera, a LiDAR (Light Detection and Ranging/Laser Imaging Detection and Ranging), a radar, a sonar, and the like.

The internal sensor 42 acquires internal data as sensor data from an inner space which is the internal environment of the moving body 2. The internal sensor 42 may acquire the internal data by sensing particular movement physical quantities in the space inside the moving body 2. The physical-quantity-sensing-type internal sensor 42 is at least one type selected from, for example, a travel speed sensor, an acceleration sensor, a gyro sensor, and the like. The internal sensor 42 may acquire the internal data by sensing particular states of the boarded operator in the space inside the moving body 2. The operator-sensing-type internal sensor 42 is at least one type selected from, for example, a sound sensor 42a, a driver status monitor (registered trademark), a vital sensor, a seating sensor, an actuator sensor, a vehicle interior equipment sensor, a mouse, a track ball, and the like. Here, particularly, the sound sensor 42a senses sounds generated by the boarded operator of the moving body 2.

The communication system 5 acquires, by wireless communication, communication data that can be used by the control system 3. The communication system 5 may receive positioning signals from artificial satellites of a GNSS (Global Navigation Satellite System) that are in the space outside the moving body 2. The positioning-type communication system 5 is, for example, a GNSS receiver or the like. The communication system 5 may transmit and receive communication signals to and from a V2X system that is in the space outside the moving body 2. The V2X-type communication system 5 is at least one type selected from, for example, a DSRC (Dedicated Short Range Communications) communication device, a cellular V2X (C-V2X) communication device, and the like. The communication system 5 may transmit and receive communication signals to and from a terminal that is in the space inside the moving body 2. The terminal-communication-type communication system 5 is at least one type selected from, for example, Bluetooth (Bluetooth: registered trademark) equipment, Wi-Fi (registered trademark) equipment, infrared communication equipment, and the like.

The information presentation system 6 presents notification information intended for the boarded operator in the moving body 2. The information presentation system 6 may present the notification information by giving a visual stimulus to the boarded operator. The visual-stimulus-type information presentation system 6 is at least one type selected from, for example, an HUD (Head-Up Display), an MFD (Multi-Function Display), a combination meter, a navigation unit, a light-emitting unit, and the like. The information presentation system 6 may present the notification information by giving an auditory stimulus to the boarded operator. The auditory-stimulus-type information presentation system 6 is at least one type selected from, for example, a speaker, a buzzer, a vibration unit, and the like.

The control system 3 includes at least one dedicated computer. The dedicated computer included in the control system 3 is connected to the sensor system 4, the communication system 5, and the information presentation system 6 via at least one type selected from, for example, a LAN (Local Area Network) line, a wire harness, an internal bus, a wireless communication line, and the like.

The dedicated computer included in the control system 3 may be an integration ECU (Electronic Control Unit) that integrates driving control of the moving body 2. The dedicated computer included in the control system 3 may be a determination ECU that determines driving tasks in driving control of the moving body 2. The dedicated computer included in the control system 3 may be a monitoring ECU that monitors driving control of the moving body 2. The dedicated computer included in the control system 3 may be an evaluation ECU that evaluates driving control of the moving body 2.

The dedicated computer included in the control system 3 may be a navigation ECU that navigates the moving body 2 through a traveling route. The dedicated computer included in the control system 3 may be a locator ECU that estimates self-state quantities of the moving body 2. The dedicated computer included in the control system 3 may be an actuator ECU that controls travel actuators of the moving body 2. The dedicated computer included in the control system 3 may be an HCU (HMI (Human Machine Interface) Control Unit) that controls information presentation by the information presentation system 6 in the moving body 2. The dedicated computer included in the control system 3 may be, for example, a computer which is not included the moving body 2, but is included in an external center, a mobile terminal, or the like that can communicate via the V2X-type communication system 5.

The dedicated computer included in the control system 3 has at least one memory 30 and at least one processor 32. The memory 30 is at least one type of non-transitory tangible storage medium (non-transitory tangible storage medium) selected from, for example, a semiconductor memory, a magnetic medium, an optical medium, and the like that non-transitorily stores computer-readable programs, data, and the like. The processor 32 includes, as a core, at least one type selected from, for example, a CPU (Central Processing Unit), a GPU (Graphics Processing Unit), a RISC (Reduced Instruction Set Computer)-CPU, a DFP (Data Flow Processor), a GSP (Graph Streaming Processor), and the like.

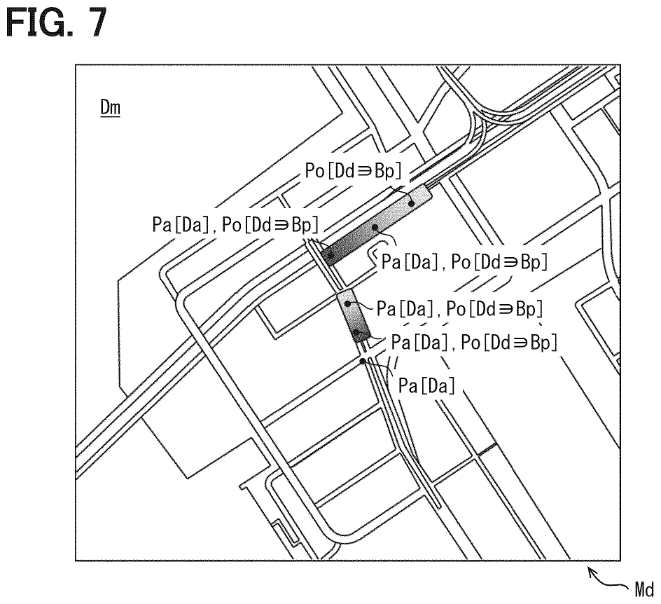

In the control system 3, the memory 30 stores a digital map Md (see FIG. 7 mentioned later) to be provided to the processing system 1 as a map including map data Dm that can be used for automated driving of the moving body 2. The memory 30 acquires and stores the latest map data Dm by, for example, communication with an external center via the V2X-type communication system 5, or the like. Here, the map data Dm is two-dimensional or three-dimensional data as information representing the traveling environment of the moving body 2. The two-dimensional map data Dm may include orthoimages. As the three-dimensional map data Dm, high-precision map data may be adopted.

For example, regarding roads, such map data Dm may include road information representing at least one type selected from positional coordinates, shapes, road conditions, lane structures, connection structures, roadside structures, parking structures, relationships inside and outside intersections, parallel structures relative to sidewalks, intersection structures relative to railroads, and the like. The map data Dm may include marking information representing at least one type selected from traffic signs and road markings that form parts of roads, positional coordinates, shapes, orientations, hues, and types, for example, regarding road surface markings, and the like. The map data Dm may include feature information representing at least one type selected from structures and traffic lights facing roads, positional coordinates, shapes, orientations, hues, and types, for example, regarding boom barriers, and the like. As traffic rules, for example, the map data Dm may include rule information representing at least one type selected from legally permitted speeds, passage distributions, passage directions, priorities at intersections, whether it is required to or not required to stop, whether caution is required or not required, whether it is permitted or not permitted to park, whether it is permitted or not permitted to change lanes, whether it is permitted or not permitted to make right or left turns, whether it is permitted or not permitted to turn around, whether or not there are restrictions, passage rules of each type of operation by traffic lights, and the like.

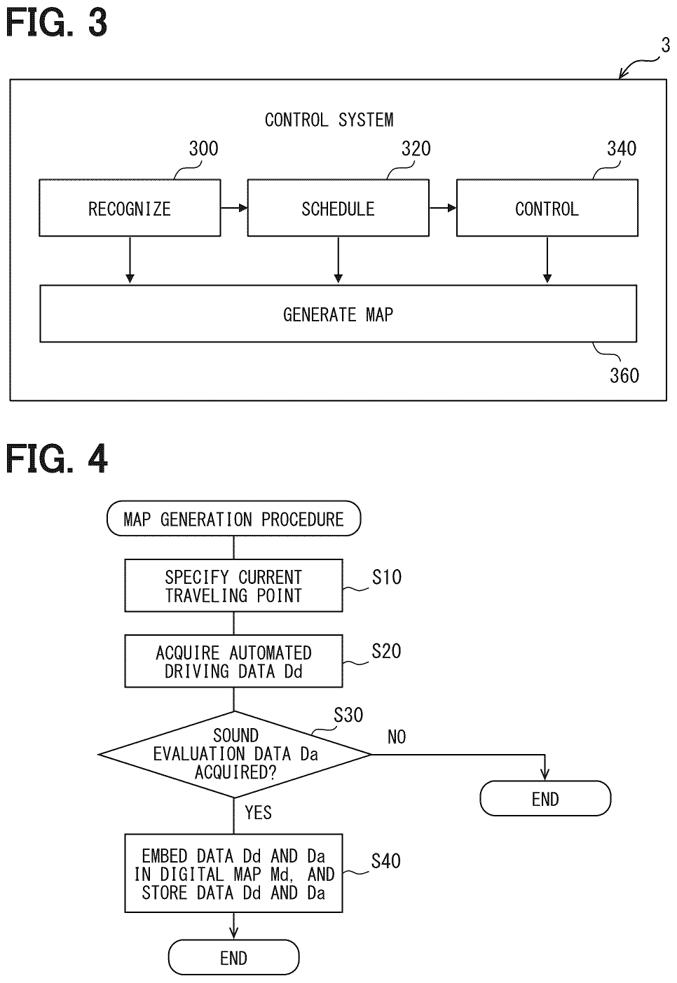

In the control system 3 depicted in FIG. 2, the processor 32 executes multiple commands included in control programs stored on the memory 30 for executing automated driving control of the moving body 2 including a process of generating the digital map Md. Thereby, the control system 3 constructs multiple functional blocks for executing automated driving control of the moving body 2 including the process of generating the digital map Md. As depicted in FIG. 3, the multiple functional blocks constructed in the control system 3 includes a recognition block 300, a scheduling block 320, a control block 340, and a map generation block 360.

The recognition block 300 acquires sensor data from the external sensor 40 and the internal sensor 42 of the sensor system 4. The recognition block 300 acquires communication data from the communication system 5. The recognition block 300 acquires the map data Dm from the memory 30. The recognition block 300 recognizes the environment inside and outside the moving body 2 by fusing the acquired data as inputs. Furthermore, the recognition block 300 recognizes sounds generated by the boarded operator of the moving body 2 based on sensor data from the sound sensor 42a.

The scheduling block 320 acquires recognition data representing recognition results from the recognition block 300. On the basis of the acquired recognition data, the scheduling block 320 determines, for each traveling scene, and schedules, in a time series, a future route, a future action, and a future trajectory of the moving body 2, and a future transition of interactions between the moving body 2 and other road users. At this time, the scheduling block 320 may implement the scheduling using, for example, a vehicle traveling model such as a simulation model or a machine learning model.

The control block 340 acquires a scheduling command representing scheduling results from the scheduling block 320. In accordance with the acquired scheduling command, the control block 340 implements functions of a dynamic driving task (Dynamic Driving Task) to control automated driving of the moving body 2. At this time, multiple travel actuators that cause the moving body 2 to show a behavior according to the scheduling command are given, from the control block 340, control commands for implementing the behavior.

The map generation block 360 acquires the recognition data from the recognition block 300. The map generation block 360 acquires, from the scheduling block 320, determination data representing determination results at the time of the scheduling, and the scheduling command. The map generation block 360 acquires a control command from the control block 340. In accordance with a map generation procedure depicted in FIG. 4 as a control procedure, the map generation block 360 executes a generation method of generating the digital map Md. The map generation procedure is executed repeatedly while the moving body 2 is activated. Each “S” in the map generation procedure means one of multiple steps executed in accordance with multiple commands included in a map generation program in the control programs.

At S10, based on the recognition data from the recognition block 300, the map generation block 360 specifies the current traveling point of the moving body 2 (hereinafter, referred to as a current traveling point). Next, at S20, the map generation block 360 acquires automated driving data Dd representing the automated driving state of the moving body 2 at the current traveling point. At this time, the map generation block 360 generates the automated driving data Dd based on the recognition data from the recognition block 300, the determination data and scheduling command from the scheduling block 320, and the control command from the control block 340.

Specifically, the automated driving data Dd based on the recognition data may include at least one type selected from, for example, recognition results such as the type, position, traveling direction, speed, or acceleration/deceleration of an object recognized at the recognition block 300. The automated driving data Dd based on the recognition data may include, as the results of the recognition at the recognition block 300, at least one type selected from road information, marking information, feature information, rule information, and the like which are illustrated regarding the map data Dm described above.

The automated driving data Dd based on the determination data may include, as determination result at the time of the scheduling at the scheduling block 320, at least one type selected from road information, marking information, feature information, rule information, and the like which are illustrated regarding the map data Dm described above. The automated driving data Dd based on the determination data may include at least one type of determination result selected from, for example, the type of an traveling environment, the traveling position in a travel lane, the road condition of the travel lane, whether or not there is an object in the travel lane, the operational state of a traffic light, and the like about a traveling scene determined at the time of the scheduling at the scheduling block 320. Here, it may be assumed that the road condition of the travel lane is at least one type selected from, for example, flooding, a crack, accumulation of snow, accumulation of ash, and the like. It may be assumed that whether or not there is an object in the travel lane is whether or not there is at least one type selected from, for example, a manhole, a bridge joint, a cone, and the like.

The automated driving data Dd based on the determination data may include at least one type of future transition (predicted trajectory) selected from, for example, the positional coordinates, traveling direction, speed, acceleration/deceleration, and the like of a second road user determined as an obstacle at the time of the scheduling at the scheduling block 320. The automated driving data Dd based on the determination data may include, in association with the future transition, at least one type selected from, for example, the type, size, and the like of the second road user determined as the obstacle at the time of the scheduling at the scheduling block 320. Here, it may be assumed that the second road user is at least one type selected from a vulnerable road user like, for example, a human such as a pedestrian, or an animal, and an invulnerable road user like, for example, a vehicle such as an automobile, a truck, a motorcycle, or a bicycle.

The automated driving data Dd based on the scheduling command and/or the control commands may include at least one type of actual parameter selected from, for example, the trajectory, position, speed, acceleration/deceleration, yaw angle, yaw rate, steering angle, margin from the second road user, and the like of the moving body 2 controlled by the control block 340. The automated driving data Dd based on the scheduling command and/or the control commands may include at least one type of target parameter selected from, for example, the trajectory, position, speed, acceleration/deceleration, yaw angle, yaw rate, steering angle, and the like of the moving body 2 controlled by the control block 340. The automated driving data Dd based on the scheduling command and/or the control commands may include the deviation between such at least one type of actual parameter and the corresponding at least one type of target parameter.

At subsequent S30, the map generation block 360 determines whether or not sound evaluation data Da representing evaluation by the boarded operator about automated driving state of the moving body 2 at the current traveling point has been acquired. At this time, the map generation block 360 determines whether or not the sound evaluation data Da has been acquired based on sound recognition data representing a sound recognition result in the recognition data from the recognition block 300.

Specifically, the sound recognition data determined as the sound evaluation data Da is deployed in advance to the boarded operator with the content of evaluation sounds being expressed as patterns such that the evaluation sounds represent sounds of evaluation by the boarded operator about a traveling scene and an actual behavior at the current traveling point. Here, an evaluation sound of the traveling scene evaluates, by a sound, at least one type selected from, for example, whether or not there is an obstacle to the moving body 2, the states of traffic lights involved in traveling of the moving body 2, the type of the traveling environment at the current traveling point, and the like. An evaluation sound of the actual behavior evaluates, by a sound, at least one type selected from, for example, sudden braking, sharp turn, rapid deceleration, and the like of the moving body 2. Specific examples of such evaluation sounds include “green traffic light, but sudden braking,” “no obstacle on the lane ahead, but sharp turn,” and the like.

At S30, the map generation block 360 may acquire, as the sound evaluation data Da, the sound recognition data itself from the recognition block 300. At S30, the map generation block 360 may convert the sound recognition data from the recognition block 300 into text data, and then acquire, as the sound evaluation data Da, the text data after the conversion. In either case, the map generation block 360 at S30 may determine whether or not the sound evaluation data Da represents an evaluation sound, and thereby make a determination that the sound evaluation data Da has been acquired in a case where the result of the determination is Yes.

In a case where it is determined at S30 that the sound evaluation data Da has been acquired, the map generation procedure proceeds to S40. At S40, as dynamic data to be associated with the current traveling point in the map data Dm on the digital map Md, the map generation block 360 embeds the acquired automated driving data Dd and sound evaluation data Da on the digital map Md of the memory 30, and stores the digital map Md. At this time, the digital map Md in which a timestamp also is embedded in association with the current traveling point may be stored. Upon completion of the execution of S40 in this manner, the current execution of the map generation procedure for the current traveling point is ended. In a case where it is determined at S30 that the sound evaluation data Da has not been acquired also, the current execution of the map generation procedure for the current traveling point is ended.

The processing system 1 depicted in FIG. 1 is installed in, for example, an external center such as a data analysis center. The processing system 1 includes an information presentation unit 7 and an input unit 8. The information presentation unit 7 presents information to a processing operator of the processing system 1. The information presentation unit 7 may be, for example, a liquid crystal panel, an organic EL panel, or the like that displays image data including the digital map Md. The information presentation unit 7 may be, for example, a speaker or the like that outputs, as sounds, the sound evaluation data Da included in the digital map Md. The input unit 8 accepts inputs from the processing operator. The input unit 8 is at least one type selected from, for example, a mouse, a track ball, a keyboard, and the like. Here, the information presentation unit 7 and the input unit 8 may be configured to cooperate with each other to be able to provide a GUI (Graphical User Interface) to the processing operator. In the explanation above, the processing operator may be a human different from the boarded operator, or may be the same human as the boarded operator.

The processing system 1 further includes a processing computer 1a as at least one dedicated computer. The processing computer 1a is connected to the information presentation unit 7 and the input unit 8 via at least one type selected from, for example, a LAN (Local Area Network) line, a wire harness, an internal bus, a wireless communication line, and the like.

The processing computer 1a has at least one memory 10 and at least one processor 12. The memory 10 is at least one type of non-transitory tangible storage medium (non-transitory tangible storage medium) selected from, for example, a semiconductor memory, a magnetic medium, an optical medium, and the like that non-transitorily stores computer-readable programs, data, and the like. The processor 12 includes, as a core, at least one type selected from, for example, a CPU, a GPU, an RISC-CPU, and the like.

In the processing computer 1a, the memory 10 stores the digital map Md provided from the control system 3 that controls at least one moving body 2. The provision of the digital map Md from the control system 3 to the processing computer 1a is implemented by data transfer via a communication network between the control system 3 and the processing computer 1a or by physical movement of the memory 30 between the control system 3 and the processing computer 1a. Here, in the case of physical movement of the memory 30, the digital map Md may be transferred between the memory 30 connected to the processing computer 1a and the memory 10 of the processing computer 1a. In the case of physical movement of the memory 30, the memory 30 retaining the digital map Md may be substantially included as part of the memory 10 by being connected to the processing computer 1a.

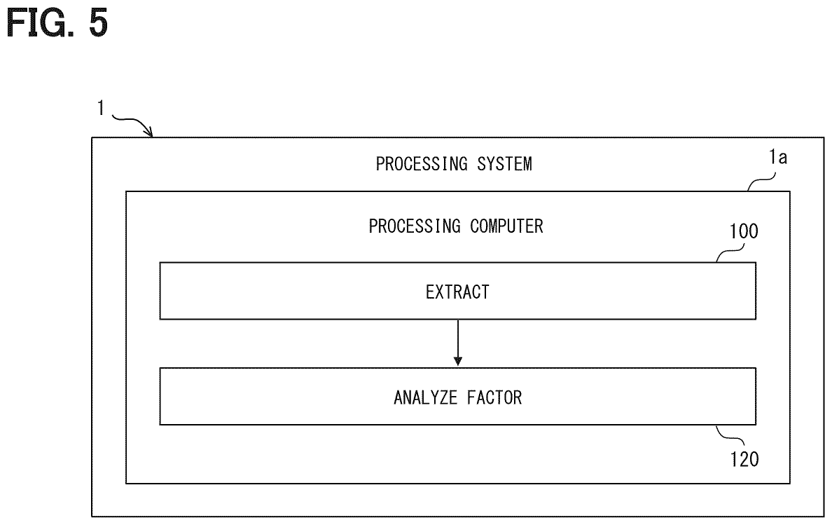

In the processing computer 1a, the processor 12 executes multiple commands included in a processing program stored on the memory 10 in order for the processing system 1 to execute an automated driving-related process of the moving body 2. Thereby, the processing computer 1a constructs multiple functional blocks in order for the processing system 1 to execute the automated driving-related process of the moving body 2. As depicted in FIG. 5, the multiple functional blocks constructed in the processing computer 1a include an extraction block 100 and a factor analysis block 120.

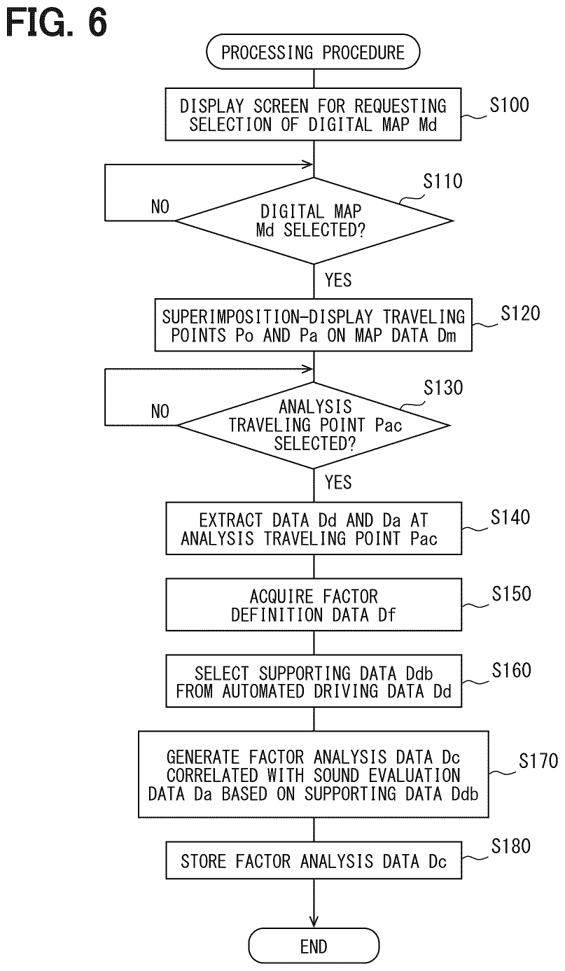

These blocks 100 and 110 execute a processing method for executing the automated driving-related process of the moving body 2 in accordance with a processing procedure depicted in FIG. 6. The present processing procedure is executed in response to a command from the processing operator of the processing system 1. Each “S” in the processing procedure means one of multiple steps executed in accordance with multiple commands included in the processing program.

At S100, as the automated driving-related process of the moving body 2, the extraction block 100 causes the information presentation unit 7 to display a selection requesting image for requesting to select a digital map Md for starting a factor analysis process of the automated driving state. Next, at S110, the extraction block 100 determines whether or not a digital map Md for which the factor analysis process is started is selected from digital maps Md stored on the memory 10 by input operation on the input unit 8 by the processing operator. If it is determined, as a result, that a digital map Md is selected, the processing procedure proceeds to S120.

At S120, as depicted in FIG. 7, the extraction block 100 causes the information presentation unit 7 to display map data Dm included in the selected digital map Md (hereinafter, referred to as the digital map Md simply). At this time, the extraction block 100 displays traveling points Po where the values of a particular reference parameter Bp are outside a tolerable range in the automated driving data Dd included in dynamic parameters embedded in association with traveling points of the moving body 2 on the digital map Md such that the traveling points Po are superimposed on the map data Dm. Along with this, the extraction block 100 displays traveling points Pa associated with the sound evaluation data Da in the dynamic parameters embedded in association with the traveling points of the moving body 2 on the digital map Md such that the traveling points Pa are superimposed on the map data Dm.

Specifically, as the reference parameter Bp, at least one type selected from, for example, an actual parameter such as the trajectory, position, speed, acceleration/deceleration, yaw angle, yaw rate, steering angle, or margin from a second road user representing an actual behavior of the moving body 2 according to automated driving control, and a deviation of the actual parameter from a target parameter is adopted. The extraction block 100 extracts traveling points Po where the values of the reference parameter Bp exceed a threshold or are equal to or greater than the threshold, and are outside a tolerable range by a time series analysis or a frequency analysis of the parameter Bp, and superimposition-display the traveling points Po on the map data Dm.

At S120, in a case where traveling points Pa that are associated with the sound evaluation data Da, and match traveling points Po where the values of the reference parameter Bp are outside the tolerable range, the traveling points Pa may be superimposition-displayed on the traveling points Po as depicted in FIG. 7. At S120, as depicted in FIG. 7, a traveling area where there are consecutive traveling points Po where the values of the reference parameter Bp are outside the tolerable range may also be superimposition-displayed on the map data Dm like a heatmap representing the differences between the values of the reference parameter Bp and the threshold of the tolerable range. FIG. 7 schematically depicts, like a heatmap with gradations, a state where display colors change depending on the magnitudes of the differences between the values of the reference parameter Bp and the threshold of the tolerable range.

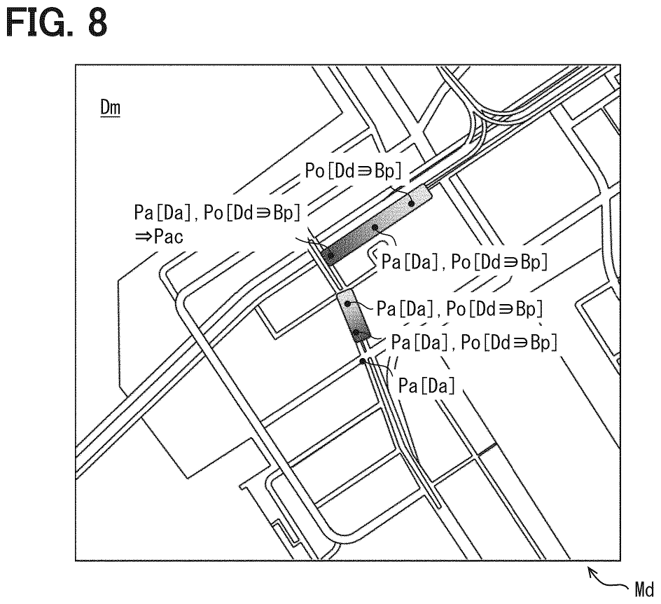

As depicted in FIG. 6, at subsequent S130, the extraction block 100 determines whether or not an analysis traveling point Pac which is the target of the factor analysis process is selected by input operation on the input unit 8 by the processing operator from traveling points Pa that are associated with sound evaluation data Da including traveling points Pa matching traveling points Po where the values of the reference parameter Bp are outside the tolerable range. If it is determined, as a result, that such an analysis traveling point Pac is selected, the processing procedure proceeds to S140. At this time, in a case where an analysis traveling point Pac matching a traveling point Po where the value of the reference parameter Bp is outside the tolerable range is selected as depicted in FIG. 8, this means that the reference parameter Bp is equivalent to a starting criterion of the factor analysis process.

At S140 depicted in FIG. 6, the extraction block 100 extracts automated driving data Dd and sound evaluation data Da at the selected analysis traveling point Pac (hereinafter, referred to as the analysis traveling point Pac simply) from dynamic parameters embedded in the digital map Md. At this time, the entire automated driving data Dd embedded in the digital map Md in association with the analysis traveling point Pac may be extracted, or part of the entire data Dd that includes the reference parameter Bp may be extracted.

At subsequent S150, the factor analysis block 120 acquires, from the memory 10, factor definition data Df which functions as the base of the factor analysis process. At this time, as the factor definition data Df, data correlated with the automated driving data Dd at the analysis traveling point Pac, and the sound evaluation data Da at the point Pac is read out.

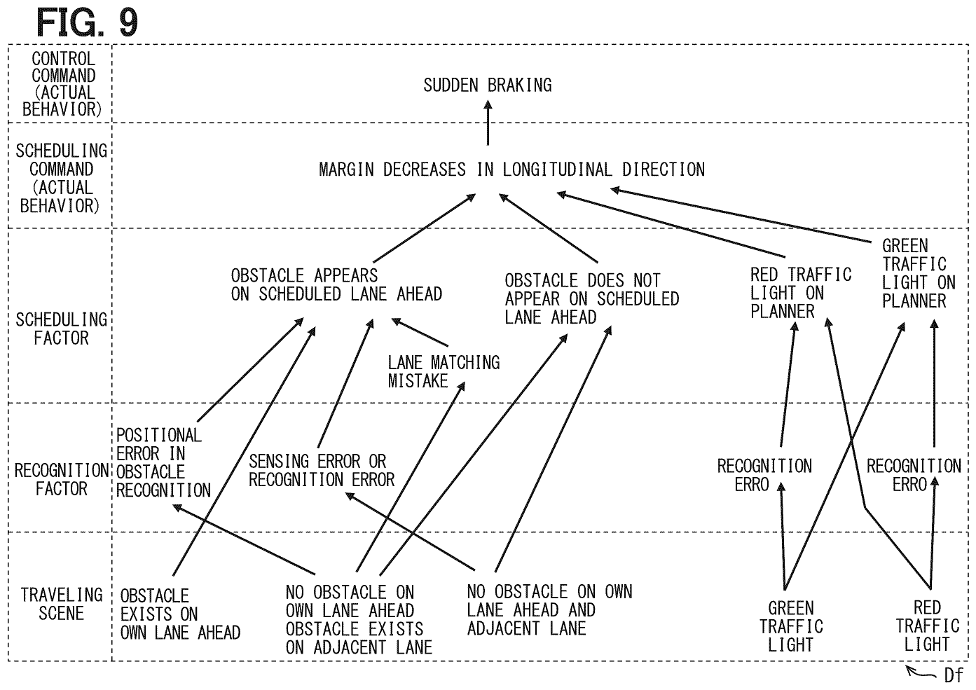

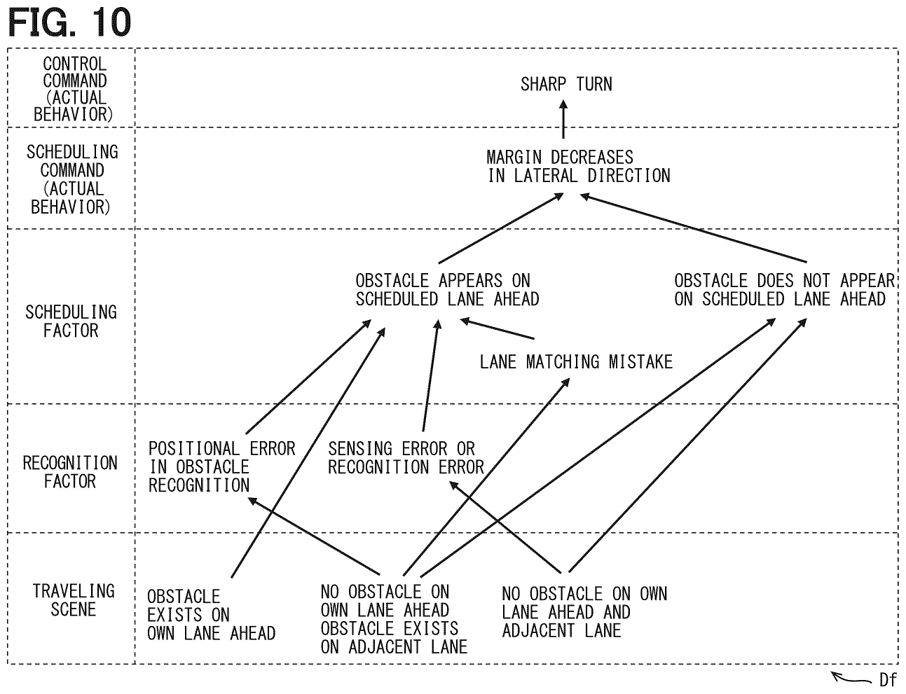

Specifically, as illustrated in FIGS. 9 and 10, the factor definition data Df defines the causal relationship from traveling scenes until actual behaviors of the moving body 2 at the analysis traveling point Pac, and is stored on the memory 10. Particularly, the factor definition data Df of the first embodiment defines, regarding traveling scenes in the real world, a time series branch tree until a command generated by processing factors at the blocks 300, 320, and 340 of the control system 3 causes the moving body 2 to show an actual behavior. The factor analysis block 120 determines a traveling scene and an actual behavior to determine the factor definition data Df based on at least the reference parameter Bp in the automated driving data Dd at the analysis traveling point Pac, and the sound evaluation data Da at the point Pac. The factor analysis block 120 selects, from the memory 10, the factor definition data Df corresponding to the thus-determined traveling scene and actual behavior.

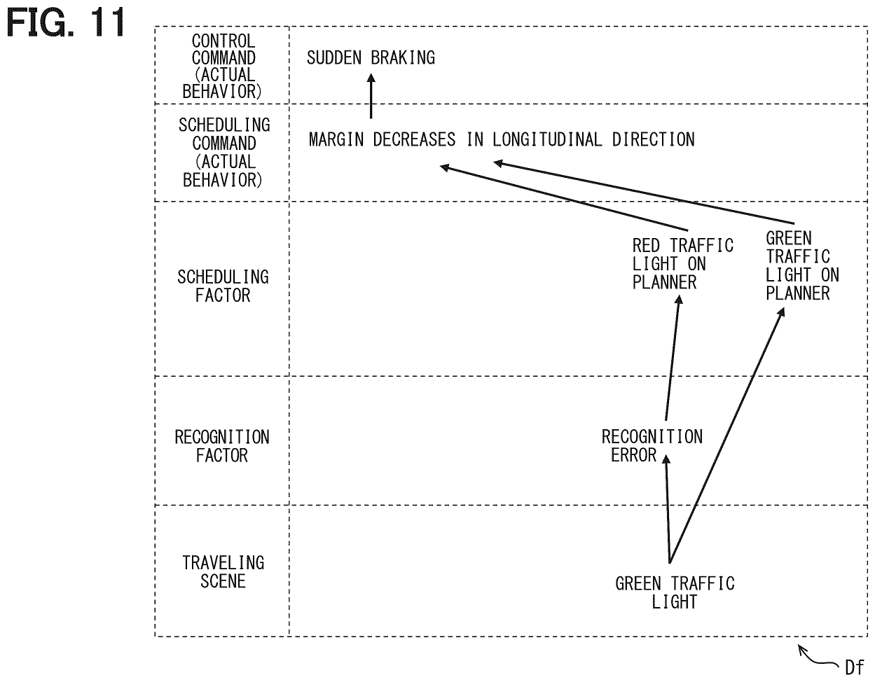

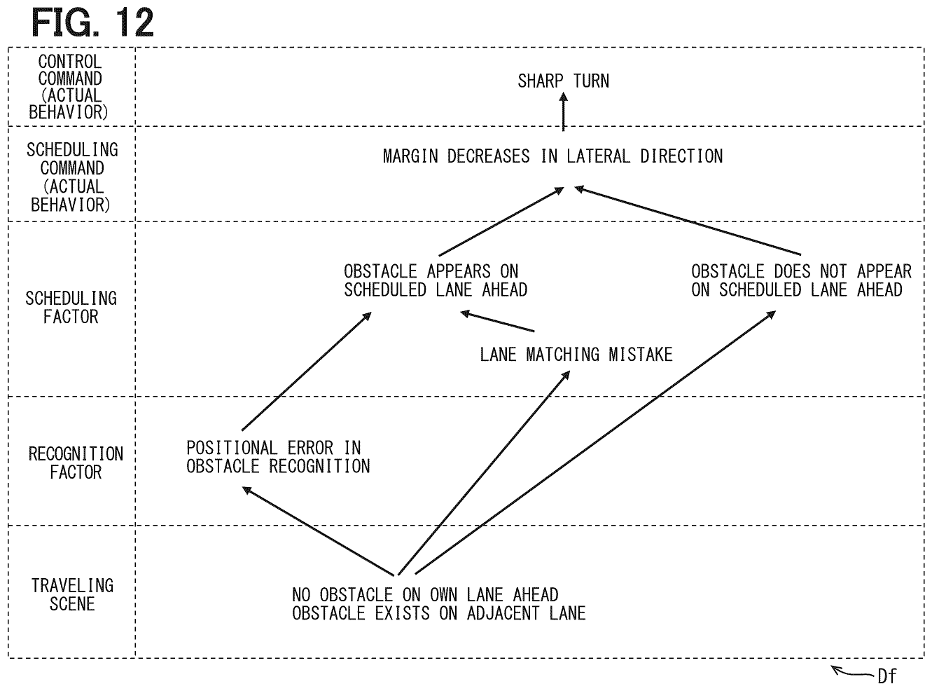

Here, factor definition data Df illustrated in FIG. 9 defines the time series causal relationship regarding traveling scenes that cause the moving body 2 to perform sudden braking as an actual behavior, recognition factors at the recognition block 300, scheduling factors and a scheduling command at the scheduling block 320, and a control command at the control block 340. On the other hand, factor definition data Df illustrated in FIG. 10 defines the time series causal relationship regarding traveling scenes that cause the moving body 2 to perform sharp turn as an actual behavior, recognition factors at the recognition block 300, scheduling factors and a scheduling command at the scheduling block 320, and a control command at the control block 340. FIGS. 9 and 10 illustrate the factor definition data Df using branch trees from multiple traveling scenes for a single actual behavior. It should be noted that it is sufficient if, as the factor definition data Df selected at S150, a tree portion according to the number of determinations of traveling scenes and actual behaviors by the factor analysis block 120 is at least read out from the memory 10 as illustrated in FIGS. 11 and 12 corresponding to FIGS. 9 and 10, respectively.

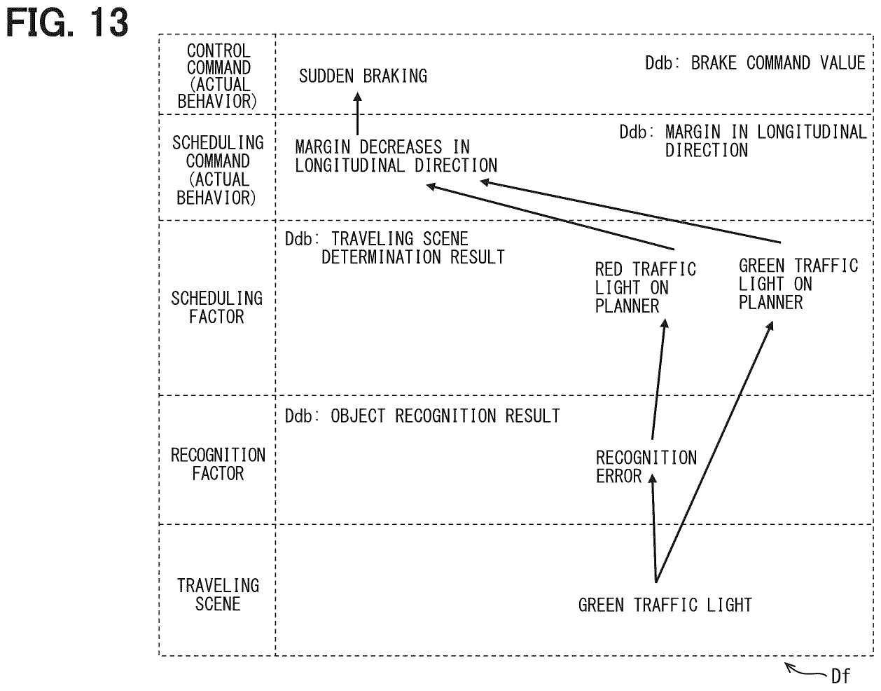

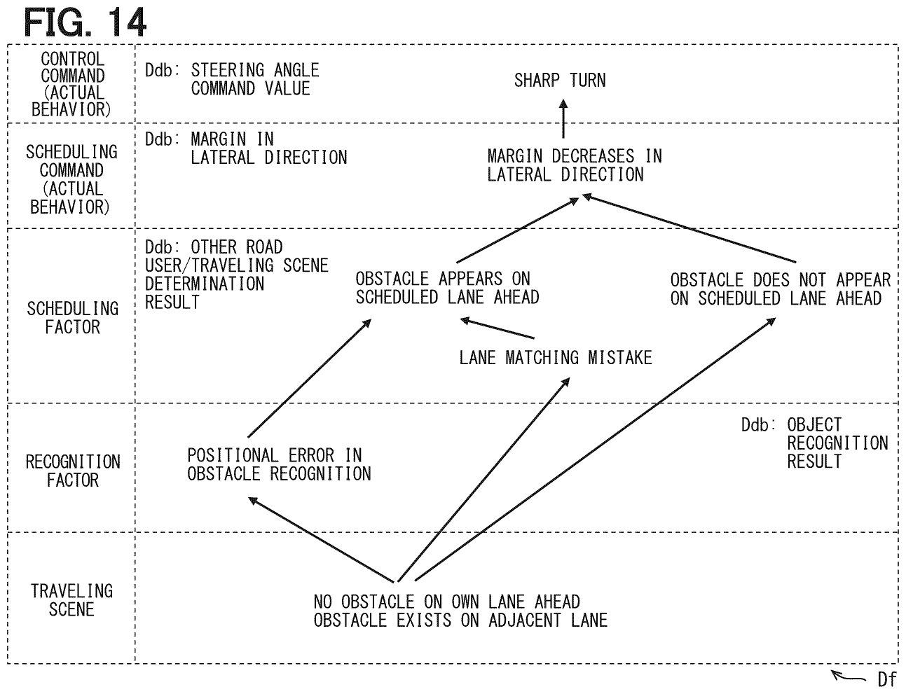

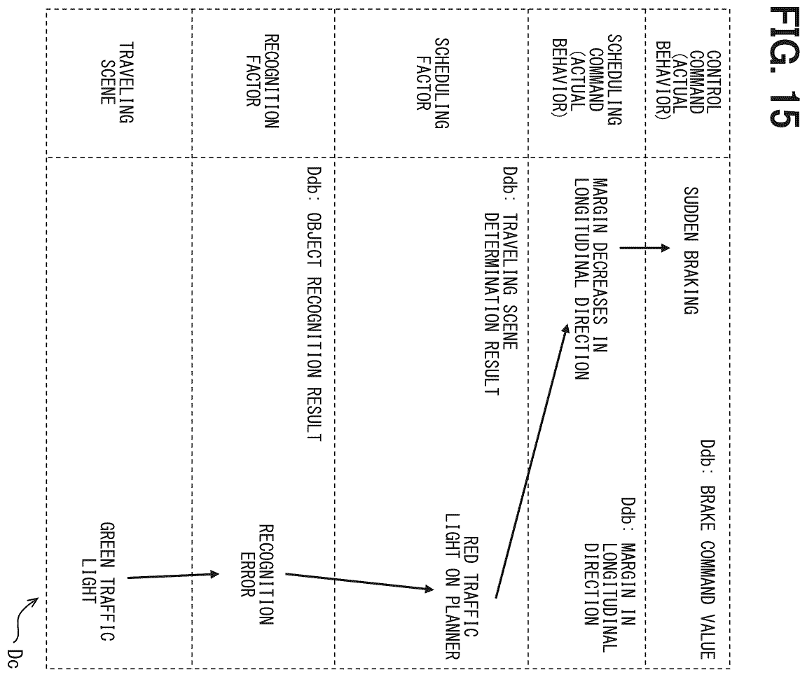

As depicted in FIG. 6, at subsequent S160, the factor analysis block 120 selects supporting data Ddb to support each of factors and commands defined in the factor definition data Df having been read out (hereinafter, referred to as factor definition data Df simply) out of the automated driving data Dd at the analysis traveling point Pac, as illustrated in FIGS. 13 and 14. At this time, as data to support the causal relationship between the traveling scene and the actual behavior determined from the factor definition data Df correlated with the sound evaluation data Da at S150, the selected supporting data Ddb is at least the automated driving data Dd out of the automated driving data Dd and the sound evaluation data Da. Therefore, the supporting data Ddb can also be said to be data correlated with the sound evaluation data Da. At this time, in the first embodiment, the supporting data Ddb to support at least the control command out of the scheduling command and the control command may include the reference parameter Bp at the analysis traveling point Pac.

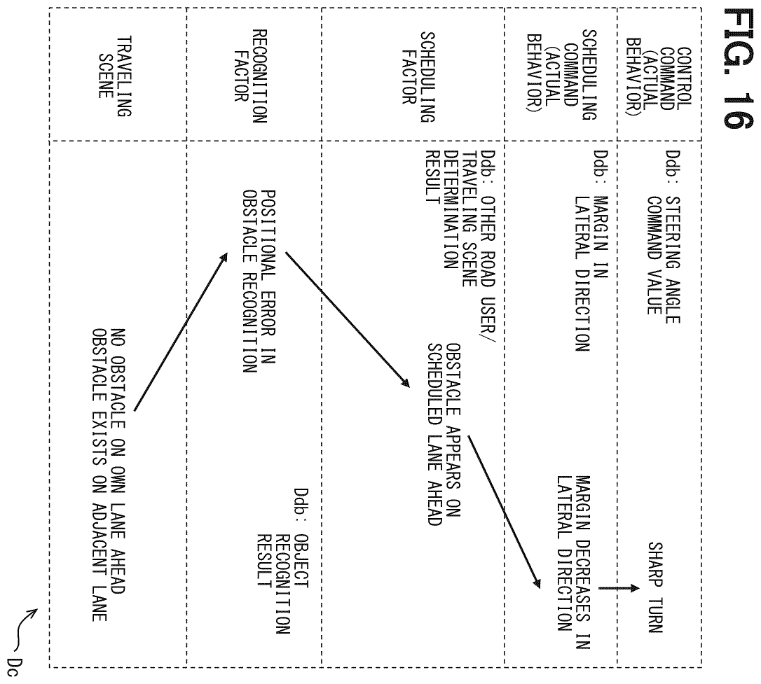

As depicted in FIG. 6, at subsequent S170, the factor analysis block 120 generates factor analysis data Dc which functions as a result of analysis of a factor of the automated driving state at the analysis traveling point Pac based on the selected supporting data Ddb (hereinafter, referred to as the supporting data Ddb simply). At this time, the factor analysis data Dc is data obtained by extracting a tree portion that maximizes the likelihood calculated from the supporting data Ddb as illustrated in FIGS. 15 and 16 as a causal relationship between the traveling scene and the actual behavior correlated with the sound evaluation data Da out of a branch tree in the factor definition data Df. Therefore, the factor analysis data Dc can also be said to be data correlated with the sound evaluation data Da. At this time, in the first embodiment, the factor analysis data Dc may be generated based on the supporting data Ddb including the reference parameter Bp at the analysis traveling point Pac as the supporting data Ddb to support at least the control command out of the scheduling command and the control command.

As depicted in FIG. 6, at subsequent S180, the factor analysis block 120 accumulates the generated factor analysis data Dc by storage on the memory 10. At this time, as illustrated in FIGS. 15 and 16, the factor analysis data Dc may be stored on the memory 10 in association with the supporting data Ddb. At this time, the factor analysis data Dc may be stored on the memory 10 in association with at least the map data Dm in the digital map Md. The thus-accumulated factor analysis data Dc may be given as feedback to, for example, development or designing of a vehicle traveling model or the like to be used for the scheduling block 320. The factor analysis data Dc may be used for maintenance including calibration of the moving body 2. The factor analysis data Dc may be used for updating of the digital map Md or the map data Dm included in the digital map Md.

### (Effects and Advantages)

Effects and advantages of the first embodiment are explained below.

In the first embodiment, the automated driving data Dd representing the automated driving state of the moving body 2 at the analysis traveling point Pac, and the sound evaluation data Da representing the evaluation from the boarded operator regarding the automated driving state are extracted from the dynamic data embedded in association with traveling points of the moving body 2 on the digital map Md. According to the first embodiment, the factor analysis data Dc correlated with the sound evaluation data Da is generated based on the automated driving data Dd as a result of analyzing the factor of the automated driving state at the analysis traveling point Pac. Therefore, according to the generated factor analysis data Dc, it becomes possible to extract a problem in automated driving from the analyzed factor.

According to the first embodiment, using, as the analysis traveling point Pac, a traveling point Po of the moving body 2 where the value of the reference parameter Bp, which is a determination criterion for the factor analysis, is outside the tolerable range in the automated driving data Dd, the automated driving data Dd and the sound evaluation data Da at the analysis traveling point Pac may be extracted. In this case, the factor analysis data Dc can be generated for the analysis traveling point Pac that is likely to have the reference parameter Bp that is outside the tolerable range due to a problem in automated driving. Therefore, according to the generated factor analysis data Dc, it becomes possible to highly precisely extract a problem in automated driving. Here, particularly in the first embodiment, the factor analysis data Dc in a case where it is generated based on the reference parameter Bp that reflects a problem in the automated driving data Dd makes it possible to ensure the reliability of highly precise problem extraction in automated driving.

According to the first embodiment, after selecting the supporting data Ddb as the automated driving data Dd correlated with the sound evaluation data Da, the factor analysis data Dc is generated based on the selected supporting data Ddb. Thereby, the automated driving data Dd based on which the factor analysis data Dc correlated with the sound evaluation data Da is generated can be narrowed down to the supporting data Ddb suited for factor analysis since the automated driving data Dd is correlated with the common sound evaluation data Da. Therefore, in generation of the factor analysis data Dc from which a problem in automated driving can be extracted, it becomes possible to implement a reduced load of the analysis process and shorter time of the analysis process.

According to the first embodiment, not only the automated driving data Dd representing the automated driving state of the moving body 2, but also the sound evaluation data Da representing evaluation by the boarded operator regarding the automated driving state can be acquired in real time during automated driving of the moving body 2. In the first embodiment, the acquired automated driving data Dd and sound evaluation data Da are embedded in the digital map Md as dynamic data associated with traveling points of the moving body 2, and stored on the memory 30 of the control system 3. Therefore, the digital map Md stored on the memory 30 becomes useful as the digital map Md from which a problem in automated driving can be extracted, and which is to be provided for the processing method at the processing system 1.

### Second Embodiment

A second embodiment is a modification example of the first embodiment.

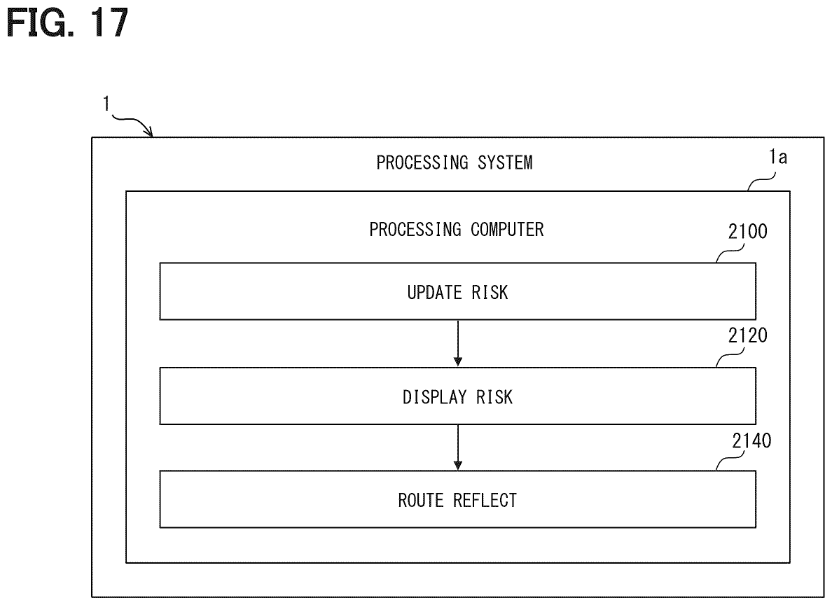

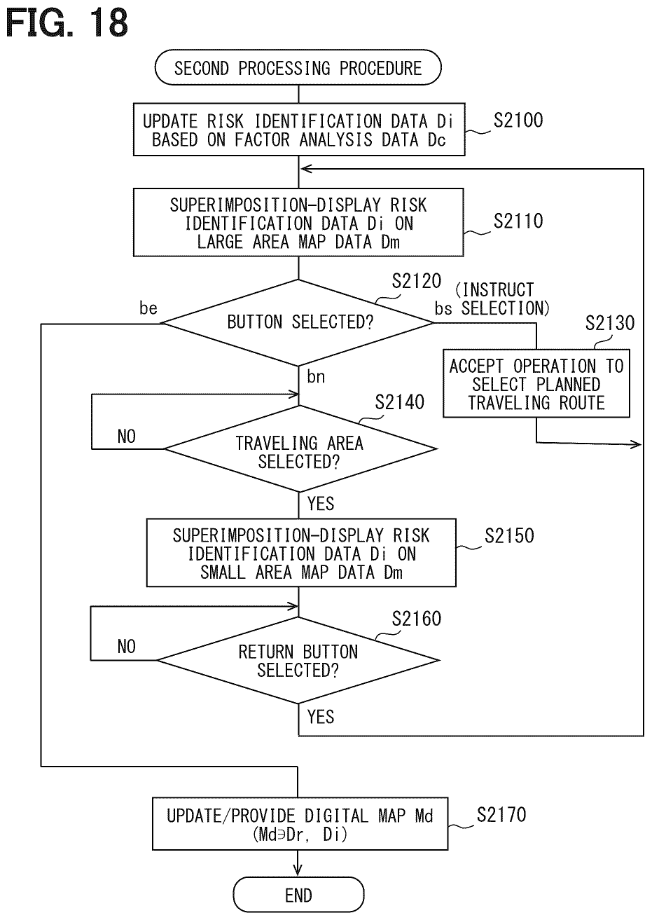

In the second embodiment, a first processing program that constructs the blocks 100 and 120, and executes, as a first processing procedure, the processing procedure explained regarding the first embodiment is stored on the memory 10 of the processing system 1. Furthermore, in the second embodiment, a second processing program that constructs blocks 2100, 2120, and 2140 depicted in FIG. 17, and executes a second processing procedure depicted in FIG. 18 is stored on the memory 10 of the processing system 1. Here, the second processing procedure may be automatically executed following the first processing procedure, or may be executed separately from the first processing procedure in accordance with a command from the processing operator of the processing system 1. Each “S” in the second processing procedure means one of multiple steps executed in accordance with multiple commands included in the second processing program.

At S2100, based on factor analysis data Dc accumulated during the at least the latest execution of the first processing procedure in past executions of the first processing procedure, a risk updating block 2100 updates risk identification data Di given to the digital map Md. Here, the risk identification data Di represents risk levels of automated driving identified for each traveling point on roads in the map data Dm included in the digital map Md. Particularly, the risk identification data Di of the present embodiment represents three levels, high, medium, and low, as risk levels of automated driving.

The risk updating block 2100 at S2100 automatically determines the risk level at the analysis traveling point Pac based on a factor of the automated driving state at the analysis traveling point Pac represented by the factor analysis data Dc in association with the digital map Md. At this time, the risk level may be determined based on the automated driving data Dd and/or the sound evaluation data Da as the supporting data Ddb stored in association with the factor analysis data Dc. For example, in a case where a factor to inhibit a lane change in the factor analysis data Dc is the number of lanes or in other cases, it becomes possible to enhance the risk level determination precision by making the determination also based on the automated driving data Dd. For example, in a case where a factor for sudden stop at a green light in the factor analysis data Dc is visual recognizability, in a case where there is a local rule, or in other cases, it becomes possible to enhance the risk level determination precision by making the determination also based on the sound evaluation data Da.

The risk updating block 2100 at S2100 automatically updates, based on the determined risk level, the risk identification data Di regarding a traveling area covering the analysis traveling point Pac on the digital map Md. At this time, on the digital map Md, not only the risk identification data Di of the traveling area covering the analysis traveling point Pac, but also the risk identification data Di of a traveling area including the factor represented by the factor analysis data Dc at the analysis traveling point Pac may be updated. At such S2100, in a case where the factor analysis data Dc is given as feedback to, for example, development or designing of a vehicle traveling model or the like, results of such development or designing may be reflected also in risk level determination and updating.

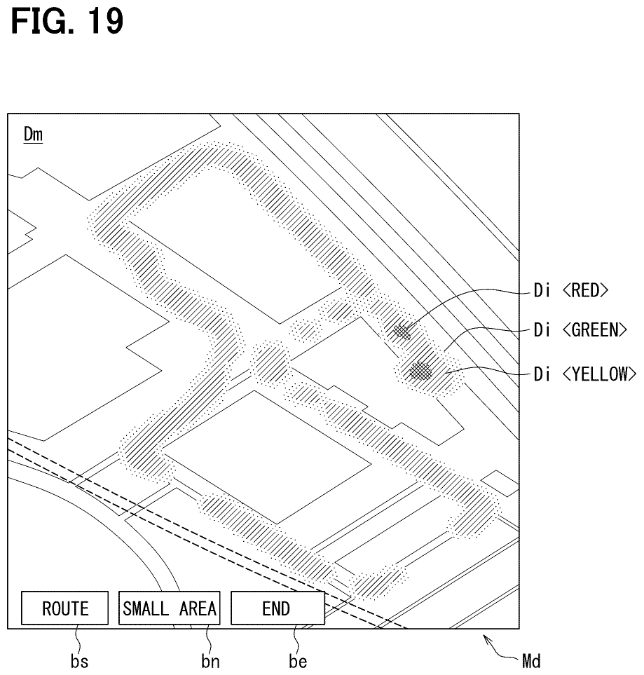

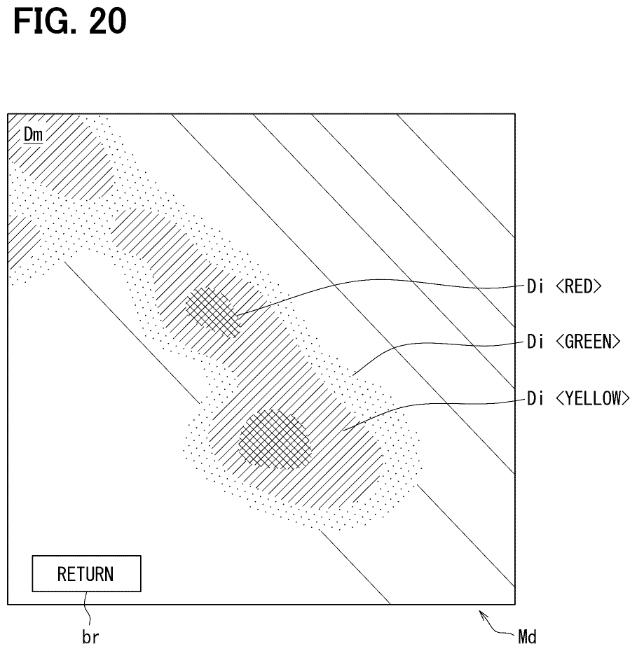

At subsequent S2110, a risk display block 2120 causes the information presentation unit 7 to display the updated risk identification data Di such that the updated risk identification data Di is superimposed on the map data Dm included in the digital map Md as depicted in FIG. 19. At this time, the risk identification data Di identifiably expresses the risk level of each traveling area defined to include multiple traveling points on roads in the map data Dm. Particularly, the risk identification data Di of the present embodiment is displayed like a heatmap with different colors, for example, red, yellow, and green, in accordance with risk levels of high, medium, and low. In FIG. 19, a state where display colors are different in accordance with risk levels is depicted schematically by differences in hatching.

Here, risk identification data Di with a high risk level may represent a traveling area where automated driving is prohibited because the automated driving performance of the moving body 2 itself is insufficient. On the other hand, risk identification data Di with a medium risk level may represent a traveling area where automated driving is restricted or the boarded operator is prompted to be cautious such that she/he can manually intervene in automated driving because the automated driving performance of the moving body 2 is insufficient to guarantee the automated driving performance. On the other hand, risk identification data Di with a low risk level may represent a traveling area where automated driving is permitted because the automated driving performance of the moving body 2 is guaranteed.

The risk display block 2120 at S2110 causes the information presentation unit 7 to display a route selection button bs, a small area display button bn, and a selection end button be such that the route selection button bs, the small area display button bn, and the selection end button be are superimposed on large area map data Dm as depicted in FIG. 19. As depicted in FIG. 18, at S2120 subsequent to S2110, the risk display block 2120 determines whether or not any one of the buttons bs, bn, and be is selected by input operation on the input unit 8 by the processing operator.

In a case where the route selection button bs is selected at S2120, the second processing procedure proceeds to S2130. At S2130, the risk display block 2120 allows the processing operator to select, by input operation on the input unit 8, a planned traveling route for making the moving body 2 travel at the time of next and subsequent generation of the digital map Md. According to the explanation up to this point, it can be said that the route selection button bs at S2120 is superimposition-displayed on the map data Dm to instruct the processing operator to select a planned traveling route while the risk identification data Di is being displayed, and accordingly S2130 can be said to be a process of accepting the selection.

The risk display block 2120 at S2130 may cause the information presentation unit 7 to display at least one type of route candidate such that the at least one type of route candidate is superimposed on the map data Dm to automatically assist selection of a planned traveling route by the processing operator. At this time, at least either the risk level represented by the risk identification data Di or a past planned traveling route corresponding to the factor analysis data Dc may be considered. At this time, in response to selection of a traveling area by input operation on the input unit 8 by the processing operator, a factor represented by the factor analysis data Dc for the selected area may be superimposition-displayed on the map data Dm. After completion of S2130, the second processing procedure returns to S2110.

In a case where the small area display button bn is selected at S2120, the second processing procedure proceeds to S2140. At S2140, the risk display block 2120 waits for selection of a traveling area that is to be displayed as an enlarged area in the large area map data Dm, by input operation on the input unit 8 by the processing operator. When a traveling area to be displayed as an enlarged area is selected as a result, the second processing procedure proceeds to S2150. At S2140, a return button which is not depicted may be displayed, and the second processing procedure may return to S2110 when the return button is selected by input operation on the input unit 8 by the processing operator.

At S2150, the risk display block 2120 causes the information presentation unit 7 to display the risk identification data Di that has been updated at S2110 such that the risk identification data Di is superimposed on a small area map data Dm which is enlarged as depicted in FIG. 20 from the large area map data Dm depicted in FIG. 19. At this time, the risk display block 2120 causes the information presentation unit 7 to display also a return button br for returning to the display of the large area map data Dm such that the return button br is superimposed on the small area map data Dm as depicted in FIG. 20. As depicted in FIG. 18, at subsequent S2160, the risk display block 2120 waits for selection of the return button br by input operation on the input unit 8 by the processing operator. If the return button br is selected as a result, the second processing procedure returns to S2110.

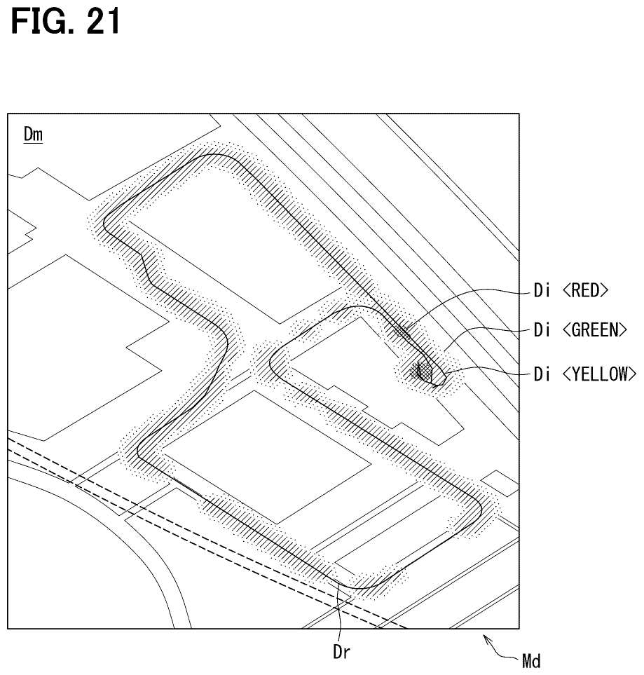

At S2120, in a case where the selection end button be is selected after the selection of the planned traveling route at S2130, the second processing procedure proceeds to S2170. At S2170, a route reflecting block 2140 updates the digital map Md stored on the memory 10 such that traveling route data Dr expressing the selected planned traveling route as depicted in FIG. 21 is added along with the risk identification data Di. At this time, the factor analysis data Dc may also be added to the digital map Md. The thus-updated digital map Md is provided from the processing system 1 to the control system 3 of the moving body 2 by data transfer via the communication network or by physical movement of the memory 30 at S2170 in FIG. 18. Upon completion of the execution of S2170, the current execution of the second processing procedure ends.

### (Effects and Advantages)

Effects and advantages unique to the second embodiment are explained below.

According to the second embodiment, the risk identification data Di that identifiably expresses a risk level based on the generated factor analysis data Dc is displayed such that the risk identification data Di is superimposed on the digital map Md. Thereby, it is possible to present the analyzed factor to the processing operator with the risk level being reflected in the analyzed factor. Therefore, it becomes possible to enhance the usefulness of the factor analysis data Dc.

According to the second embodiment, when the digital map Md is to be generated, an instruction for selection of a planned traveling route for making the moving body 2 travel is issued while the risk identification data Di is being displayed in the processing system 1. Thereby, the processing operator can select a planned traveling route necessary for generating the digital map Md in the subsequent execution of the process while taking into consideration a risk level based on the factor analysis data Dc. Therefore, it becomes possible to enhance the usefulness of the factor analysis data Dc.

According to the second embodiment, the traveling route data Dr expressing the selected planned traveling route, and the risk identification data Di are added to the digital map Md, and provided to the moving body 2. Thereby, the boarded operator can check a planned traveling route necessary for generating the digital map Md in the subsequent execution of the process while taking into consideration a risk level based on the factor analysis data Dc. Therefore, it becomes possible to enhance the usefulness of the factor analysis data Dc.

### Third Embodiment

A third embodiment is a modification example of the second embodiment.

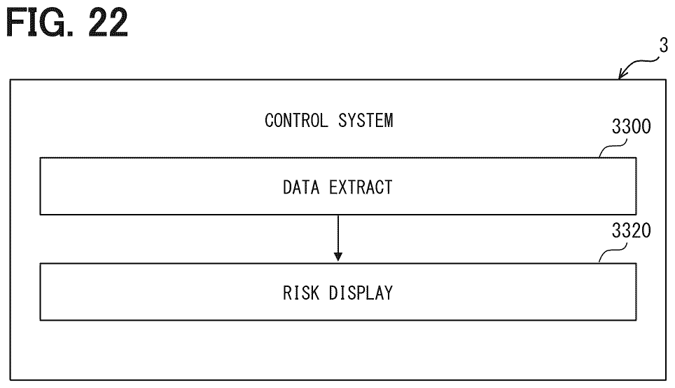

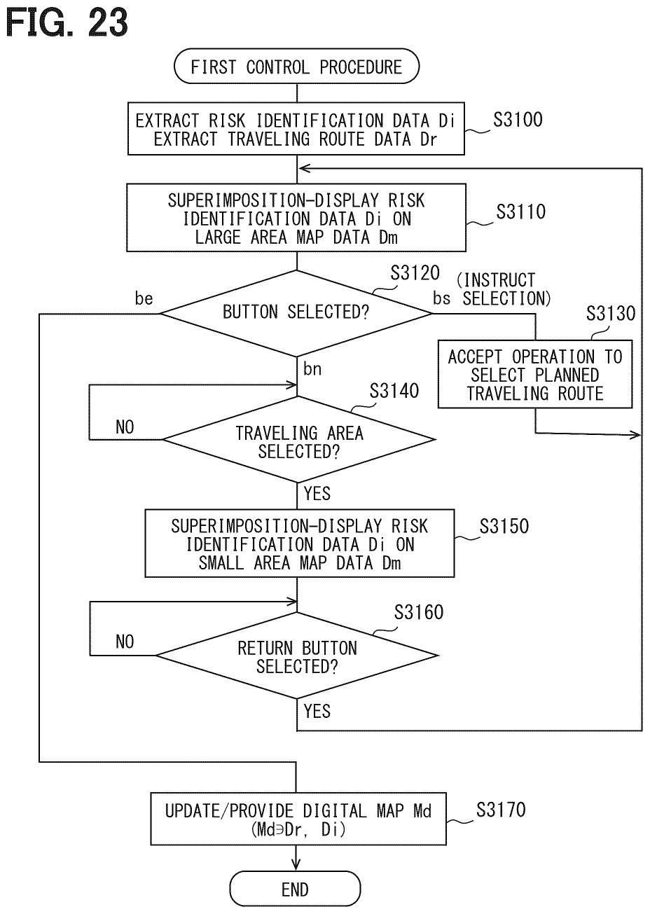

In the third embodiment, first and second processing programs that execute the first and second processing procedures, respectively, explained regarding the second embodiment are stored on the memory 10 of the processing system 1. Along with this, in the third embodiment, a second control program that constructs blocks 300, 320, 340, and 360, and executes a second control procedure including the map generation procedure explained regarding the first embodiment is stored on the memory 30 of the control system 3. In this state, furthermore, in the third embodiment, a first control program that constructs blocks 3300 and 3320 depicted in FIG. 22, and executes a first control procedure depicted in FIG. 23 is stored on the memory 30 of the control system 3. Here, the first control procedure may be automatically executed prior to the second control procedure, or may be executed separately from the second control procedure in accordance with a command from the boarded operator while the moving body 2 is activated. In the latter case particularly, the second control procedure may also be executed in response to a command from the boarded operator while the moving body 2 is activated. Each “S” in the first processing procedure means one of multiple steps executed in accordance with multiple commands included in the first processing program.

At S3100, a data extraction block 3300 reads out the latest digital map Md that is provided from the processing system 1 and is stored on the memory 10 from the memory 10. The data extraction block 3300 at S3100 extracts, from the digital map Md having been read out, the risk identification data Di and the traveling route data Dr added to the map Md. At this time, the factor analysis data Dc added to the digital map Md having been read out may also be extracted.

S3110 to S3170 following S3100 are executed corresponding to S2110 to S2170 in the second embodiment, respectively. It should be noted that the risk display block 2120 in the second processing procedure in the second embodiment is replaced with a risk display block 3320 depicted in FIG. 22 in the first control procedure of the third embodiment. The information presentation unit 7 in the second processing procedure of the second embodiment is replaced with the information presentation system 6 of the moving body 2 in the first control procedure of the third embodiment. The input unit 8 in the second processing procedure of the second embodiment is replaced with the internal sensor 42 of the moving body 2 or an input terminal that can communicate with the communication system 5 in the first control procedure of the third embodiment. The memory 10 of the processing system 1 in the second processing procedure of the second embodiment is replaced with the memory 30 of the control system 3 in the first control procedure of the third embodiment. The processing operator of the processing system 1 in the second processing procedure of the second embodiment is replaced with the boarded operator of the moving body 2 in the first control procedure of the third embodiment.

Here, at S3130 corresponding to S2130, a planned traveling route selected by the processing operator in execution of the S2130 in the processing system 1 is updated by being re-selected by the boarded operator. At S3120 and S3150 corresponding to S2120 and S2150, respectively, when the displayed selection end button be is selected in a state where a planned traveling route has not been re-selected by execution of S3130, S3170 is skipped, and the current execution of the first control procedure ends, although not depicted, but omitted in the figure.

### (Effects and Advantages)

Effects and advantages unique to the third embodiment are explained below.

According to the third embodiment, when the digital map Md is to be generated, an instruction for selection of a planned traveling route for making the moving body 2 travel is issued while the risk identification data Di is being displayed also in the moving body 2. Thereby, the boarded operator can check a planned traveling route necessary for generating the digital map Md in the subsequent execution of the process while taking into consideration a risk level based on the factor analysis data Dc, and furthermore can re-select a planned traveling route as necessary. Therefore, it becomes possible to enhance the usefulness of the factor analysis data Dc.

### Other Embodiments

Although multiple embodiments have been explained thus far, the present disclosure should not be interpreted as being limited to those embodiments, but can be applied to various embodiments within the scope not deviating from the gist of the present disclosure.

In a modification example of the first to third embodiments, the dedicated computer included in the processing system 1 and/or the control system 3 may have, as a processor, at least either a digital circuit or an analog circuit. Here, the digital circuit is at least one type selected from, for example, an ASIC (Application Specific Integrated Circuit), an FPGA (Field Programmable Gate Array), an SOC (System on a Chip), a PGA (Programmable Gate Array), a CPLD (Complex Programmable Logic Device), and the like. Such a digital circuit may have a memory having a program stored thereon.

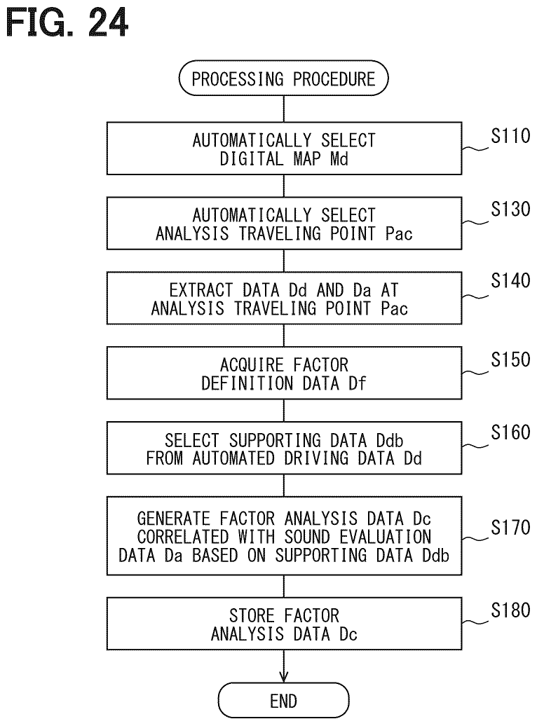

In a modification example of the first to third embodiments, traveling points Po where the values of the reference parameter Bp are outside the tolerable range may not be displayed at S120. As depicted in FIG. 24, in a modification example of the first to third embodiments, the displaying at S100 may be skipped, and the selection of the digital map Md at S110 may be automatically executed by the extraction block 100. As depicted in FIG. 24, in addition to this modification example, or, although not depicted, but omitted in the figure, in a modification example which is different from this modification example, the displaying at S120 may be skipped, and the selection of the analysis traveling point Pac at the S130 may be automatically executed by the extraction block 100.

In a modification example of the second and third embodiments, risk levels that are determined at S2100 and displayed as the risk identification data Di at S2110 and S3110 may be any of two levels, or any of four or more levels. In a modification example of the second and third embodiments, at S2150 and S3150 at which the small area map data Dm is displayed, an instruction for selection of a planned traveling route may be issued, and selection of a planned traveling route may be accepted corresponding to the set of S2120 and S2130, and the set of S3120 and S3130. In a modification example of the third embodiment, S2110 to S2160 are skipped, and thereby the digital map Md that has been updated by addition of the risk identification data Di may be provided to the control system 3 of the moving body 2 at S2170. In a modification example of the third embodiment, instead of execution of S3100, a process corresponding to S2100 may be executed by the control system 3 of the moving body 2.

In the first to third embodiments and modification examples explained above, the boarded operator may be replaced with a monitoring operator who remotely monitors the moving body 2 at, for example, an external center or the like outside the moving body 2. In a case of this modification example, the monitoring operator may function as the processing operator.

The present disclosure also includes a map generation method and a storage medium storing the digital map generated by the map generation method.

The map generation method is executed by a processor to generate the digital map to be provided to the processing method associated with automated driving of a moving body. The map generation method includes: acquiring automated driving data representing an automated driving state of the moving body; acquiring sound evaluation data representing evaluation by a sound from an operator regarding the automated driving state; embedding, as dynamic data, the automated driving data and the sound evaluation data in the digital map; and storing the digital map in which the automated driving data and the sound evaluation data are embedded in a storage medium correlated to a traveling point of the moving body.

The methods described in the present disclosure may be implemented as programs or program products, which are executed by at least one processor to perform the corresponding methods. The methods described in the present disclosure may also be implemented as storage media storing the programs or program products.

What is claimed is:

1. A processing method executed by a processor to execute a process associated with automated driving of a moving body, the processing method comprising:
extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and
generating, based on the automated driving data, factor analysis data correlated with the sound evaluation data as a result of analyzing a factor of the automated driving state at the analysis traveling point,
wherein
generating of the factor analysis data includes:
selecting the automated driving data correlated with the sound evaluation data; and
generating the factor analysis data based on the selected automated driving data.

2. The processing method according to claim 1, further comprising
displaying risk identification data, which identifiably indicates a risk level based on the generated factor analysis data, in a superimposed manner on the digital map.

3. The processing method according to claim 2, further comprising,
instructing selection of a planned traveling route along which the moving body is planned to travel while the risk identification data is being displayed when generating the digital map.

4. A processing method executed by a processor to execute a process associated with automated driving of a moving body, the processing method comprising:
extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point;
generating, based on the automated driving data, factor analysis data correlated with the sound evaluation data as a result of analyzing a factor of the automated driving state at the analysis traveling point;
displaying risk identification data, which identifiably indicates a risk level based on the generated factor analysis data, in a superimposed manner on the digital map; and
instructing selection of a planned traveling route along which the moving body is planned to travel while the risk identification data is being displayed when generating the digital map.

5. The processing method according to claim 4, further comprising:
adding, to the digital map, traveling route data indicating the selected planned traveling route and the risk identification data to the digital map; and
providing, to the moving body, the traveling route data and the risk identification data, which are added to the digital map.

6. The processing method according to claim 1, wherein
extracting the automated driving data and the sound evaluation data includes extracting the automated driving data and the sound evaluation data using, as the analysis traveling point, a traveling point of the moving body where a reference parameter that corresponds to a starting criterion of factor analysis in the automated driving data is outside a tolerable range.

7. The processing method according to claim 6, wherein
generating the factor analysis data includes generating the factor analysis data based on the reference parameter.

8. The processing method according to claim 1, further comprising
storing the generated factor analysis data in a storage medium.

9. A processing system, which executes a process associated with automated driving of a moving body, the processing system comprising:
a computer-readable non-transitory storage medium; and
a processor by executing a program stored in the computer-readable non-transitory storage, configured to:
extract, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and
generate, based on the automated driving data, factor analysis data correlated with the sound evaluation data as a result of analyzing a factor of the automated driving state at the analysis traveling point,
wherein,
in generation of the factor analysis data, the processor is configured to:
select the automated driving data correlated with the sound evaluation data; and
generate the factor analysis data based on the selected automated driving data.

10. A processing system, which executes a process associated with automated driving of a moving body, the processing system comprising:
a computer-readable non-transitory storage medium; and
a processor by executing a program stored in the computer-readable non-transitory storage, configured to:
extract, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point;
generate, based on the automated driving data, factor analysis data correlated with the sound evaluation data as a result of analyzing a factor of the automated driving state at the analysis traveling point;
display risk identification data, which identifiably indicates a risk level based on the generated factor analysis data, in a superimposed manner on the digital map; and
instruct selection of a planned traveling route along which the moving body is planned to travel while the risk identification data is being displayed when generating the digital map.

11. A processing program product stored in a computer-readable non-transitory storage medium, the processing program product comprising instruction executed by a processor to execute a process associated with automated driving of a moving body, the instructions comprising:
extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point; and
generating, based on the automated driving data, factor analysis data correlated with the sound evaluation data as a result of analyzing a factor of the automated driving state at the analysis traveling point,
wherein generating of the factor analysis data includes:
selecting the automated driving data correlated with the sound evaluation data; and
generating the factor analysis data based on the selected automated driving data.

12. A processing program product stored in a computer-readable non-transitory storage medium, the processing program product comprising instruction executed by a processor to execute a process associated with automated driving of a moving body, the instructions comprising:
extracting, from dynamic data embedded in association with traveling points of the moving body on a digital map, automated driving data representing an automated driving state of the moving body at an analysis traveling point and sound evaluation data representing evaluation by a sound from an operator regarding the automated driving state at the analysis traveling point;
generating, based on the automated driving data, factor analysis data correlated with the sound evaluation data as a result of analyzing a factor of the automated driving state at the analysis traveling point;
displaying risk identification data, which identifiably indicates a risk level based on the generated factor analysis data, in a superimposed manner on the digital map; and
instructing selection of a planned traveling route along which the moving body is planned to travel while the risk identification data is being displayed when generating the digital map.
